(19) United States
(12) Patent Application Publication
(10) Pub. No.: US 2008/0176652 A1
(43) Pub. Date: Jul. 24, 2008

(54) Gaming Machine and Control Method Thereof

(75) Inventor: Kazumasa YOSHIZAWA, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 12/014,296

(22) Filed: Jan. 15, 2008

(30) Foreign Application Priority Data
Jan. 15, 2007 (JP) 2007-005382

(51) Int. Cl. A63F 13/00

(52) U.S. Cl. 463/31

(57) ABSTRACT

A gaming machine of the present invention provides a first game and a second game different from the first game. The gaming machine comprises: a first display that displays a plurality of areas in which symbols are displayed; a second display that displays a plurality of receivers corresponding to the respective areas; and a processor. The processor operates: to control the first display to variably display and then to stop the symbols in the first game; to determine a winning of the first game in accordance with the stopped symbols; to control the second display to display an image that a ball is received in any of the receivers, in the second game; and to control the first display so that a symbol in an area corresponding to a receiver in which the ball is received is displayed in a special form, in the first game.

### CROSS REFERENCE TO RELATED APPLICATION

This application is based upon and claims the benefit of priority from the prior Japanese Patent Application No. 2007-005382, filed on Jan. 15, 2007, the entire contents of which are incorporated herein by reference.

### BACKGROUND OF THE INVENTION

1. Field of the Invention

The invention relates to a gaming machine that provides a game using symbols and an effect process, and to a control method thereof.

2. Description of Related Art

When a player inserts a game medium such as coin or bill into an insertion slot of a gaming machine and presses a spin button, symbols are scroll-displayed in a display mounted on a front of a cabinet and the respective symbols are then stopped automatically.

According to the above gaming machine, for example, when the symbols stopped on a payline constitute a predetermined combination, the predetermined number of game media are paid out (refer to U.S. Pat. No. 6,604,999 B2, U.S. Patent No. 2002065124A1). In addition, when a certain symbol referred to as scattered symbol is displayed on the display after the scroll, the predetermined number of game media are paid out in accordance with the number of scattered symbols displayed, irrespective of the payline.

### SUMMARY OF THE INVENTION

The gaming machine provides a player with a base game and a bonus game that is advantageous to the player than the base game. The base game is a game using the symbols. In the bonus game, in the display, it is displayed, as an effect, an image that balls are successively thrown toward a basket. When a predetermined number of the balls are put in the basket, a payout is awarded. Herein, when the bonus game is started, the number of the balls, which are put in the basket, is determined in advance and an effect is made in accordance with the determined result. Since the effect does not influence on a result of a game using the symbols, the player derives little pleasure from the game.

An object of the invention is to provide a gaming machine that provides a player with a new entertainment characteristic and a control method thereof.

According to a first aspect of the invention, there is provided a gaming machine that provides a first game and a second game different from the first game. The gaming machine comprises: a first display that displays a plurality of areas in which symbols are displayed; a second display that displays a plurality of receivers corresponding to the respective areas; and a processor. The processor operates: to control the first display to variably display and then to stop the symbols in the first game; to determine a winning of the first game in accordance with the stopped symbols; to control the second display to display an image that a ball is received in any of the receivers, in the second game; and to control the first display so that a symbol in an area corresponding to a receiver in which the ball is received is displayed in a special form, in the first game.

According to a second aspect of the invention, there is provided a gaming machine that provides a first game and a second game different from the first game. The gaming machine comprises: a first display that displays a plurality of areas in which symbols are displayed; a second display that displays a plurality of receivers corresponding to the respective areas; and a processor. The processor operates: to control the first display to variably display and then to stop the symbols in the first game; to determine a winning of the first game in accordance with the stopped symbols; to control the second display to display an image that a ball is received in any of the receivers, in the second game; to control the first display so that a symbol in an area corresponding to a receiver in which the ball is received is displayed in a special form, in the first game; and to change a payout number relating to a winning in accordance with the special form.

According to a third aspect of the invention, there is provided a gaming machine that provides a first game and a second game different from the first game. The gaming machine comprises: a first display that displays a plurality of areas in which symbols are displayed; a second display that displays a plurality of receivers corresponding to the respective areas; and a processor. The processor operates: to control the first display to variably display and then to stop the symbols in the first game; to determine a winning of the first game in accordance with the stopped symbols; to control the second display to display an image that a ball is received in any of the receivers, in the second game; and to control the first display so that a special symbol is fixedly displayed in an area corresponding to a receiver in which the ball is received, while the symbols are variably displayed and stopped in the first game, the special symbol being replaceable with any one of all the symbols.

According to a fourth aspect of the invention, there is provided a gaming machine that provides a first game and a second game different from the first game. The gaming machine comprises: a first display that displays a plurality of areas in which symbols are displayed; a second display that displays a plurality of receivers corresponding to the respective areas; a communicator that communicates with a host computer, the host computer managing a plurality of gaming machines including the gaming machine and dividing the gaming machines into groups which correspond to the receivers, respectively; and a processor. The processor operates: to control the first display to variably display and then to stop the symbols in the first game; to determine a winning of the first game in accordance with the stopped symbols; to control the second display to display an image that a ball is received in any of the receivers, in the second game; to control the first display so that a symbol in an area corresponding to a receiver in which the ball is received is displayed in a special form, in the first game; to transmit a data item relating to the receiver in which the ball is received to the host computer via the communicator; and to receive a payout data item about a special payout from the host computer via the communicator and to perform a special payout based on the payout data item, when the gaming machine belongs to a group corresponding to the receiver based on the data item relating to the receiver.

According to a fifth aspect of the invention, there is provided a gaming machine that provides a first game and a second game different from the first game. The gaming machine comprises: a first display that displays a plurality of areas in which symbols are displayed; a second display that displays a plurality of receivers corresponding to the respective areas; and a processor. The processor operates: to control the first display to variably display and then to stop the symbols in the first game; to determine a winning of the first game in accordance with the stopped symbols; to control the second display to display an image that a ball is received in any of the receivers, in the second game; to control the first display so that a special symbol is fixedly displayed in an area corresponding to a receiver in which the ball is received, while the symbols are variably displayed and stopped in the first game, the special symbol being replaceable with any one of all the symbols, and to change a payout number relating to a winning in accordance with the special symbol fixedly displayed.

According to a sixth aspect of the invention, there is provided a gaming machine that provides a first game and a second game different from the first game. The gaming machine comprises: a first display that displays a plurality of areas in which symbols are displayed; a second display that displays a plurality of receivers corresponding to the respective areas; a communicator that communicates with a host computer, the host computer managing a plurality of gaming machines including the gaming machine and dividing the gaming machines into groups which correspond to the receivers, respectively; and a processor. The processor operates: to control the first display to variably display and then to stop the symbols in the first game; to determine a winning of the first game in accordance with the stopped symbols; to control the second display to display an image that a ball is received in any of the receivers, in the second game; to control the first display so that a symbol in an area corresponding to a receiver in which the ball is received is displayed in a special form, in the first game; to change a payout number relating to a winning in accordance with the special form; to transmit a data item relating to the receiver in which the ball is received to the host computer via the communicator; and to receive a payout data item about a special payout from the host computer via the communicator and to perform a special payout based on the payout data item, when the gaming machine belongs to a group corresponding to the receiver based on the data item relating to the receiver.

According to a seventh aspect of the invention, there is provided a gaming machine that provides a first game and a second game different from the first game. The gaming machine comprises: a first display that displays a plurality of areas in which symbols are displayed; a second display that displays a plurality of receivers corresponding to the respective areas; a communicator that communicates with a host computer, the host computer managing a plurality of gaming machines including the gaming machine and dividing the gaming machines into groups which correspond to the receivers, respectively; and a processor. The processor operates: to control the first display to variably display and then to stop the symbols in the first game; to determine a winning of the first game in accordance with the stopped symbols; to control the second display to display an image that a ball is received in any of the receivers, in the second game; to control the first display so that a special symbol is fixedly displayed in an area corresponding to a receiver in which the ball is received, while the symbols are variably displayed and stopped in the first game, the special symbol being replaceable with any one of all the symbols; to transmit a data item relating to the receiver in which the ball is received to the host computer via the communicator; and to receive a payout data item about a special payout from the host computer via the communicator and to perform a special payout based on the payout data item, when the gaming machine belongs to a group corresponding to the receiver based on the data item relating to the receiver.

According to a eighth aspect of the invention, there is provided a gaming machine that provides a first game and a second game different from the first game. The gaming machine comprises: a first display that displays a plurality of areas in which symbols are displayed; a second display that displays a plurality of receivers corresponding to the respective areas; a communicator that communicates with a host computer, the host computer managing a plurality of gaming machines including the gaming machine and dividing the gaming machines into groups which correspond to the receivers, respectively; and a processor. The processor operates: to control the first display to variably display and then to stop the symbols in the first game; to determine a winning of the first game in accordance with the stopped symbols; to control the second display to display an image that a ball is received in any of the receivers, in the second game; to control the first display so that a special symbol is fixedly displayed in an area corresponding to a receiver in which the ball is received, while the symbols are variably displayed and stopped in the first game, the special symbol being replaceable with any one of all the symbols; to change a payout number relating to a winning in accordance with the special symbol fixedly displayed; to transmit a data item relating to the receiver in which the ball is received to the host computer via the communicator; and to receive a payout data item about a special payout from the host computer via the communicator and to perform a special payout based on the payout data item, when the gaming machine belongs to a group corresponding to the receiver based on the data item relating to the receiver.

According to a ninth aspect of the invention, there is provided a control method of a gaming machine comprising the steps of: controlling a first display to variably display and then to stop a plurality of symbols in a first game; determining a winning of the first game in accordance with the symbols stopped in the first display; controlling a second display to display an image that a ball is received in any of a plurality of receivers which correspond to the respective areas, in a second game different from the first game; and controlling the first display so that a symbol in an area corresponding to a receiver in which the ball is received is displayed in a special form, in the first game.

According to a tenth aspect of the invention, there is provided a control method of a gaming machine comprising the steps of: controlling a first display to variably display and then to stop a plurality of symbols in a first game; determining a winning of the first game in accordance with the symbols stopped in the first display; controlling a second display to display an image that a ball is received in any of a plurality of receivers which correspond to the respective areas, in a second game different from the first game; controlling the first display so that a symbol in an area corresponding to a receiver in which the ball is received is displayed in a special form, in the first game; and changing a payout number relating to a winning in accordance with the special form.

According to a eleventh aspect of the invention, there is provided a control method of a gaming machine comprising the steps of: controlling a first display to variably display and then to stop a plurality of symbols in a first game; determining a winning of the first game in accordance with the symbols stopped in the first display; controlling a second display to display an image that a ball is received in any of a plurality of receivers which correspond to the respective areas, in a second game different from the first game; and controlling the first display so that a special symbol is fixedly displayed in an area corresponding to a receiver in which the ball is received, while the symbols are variably displayed and stopped in the first game, the special symbol being replaceable with any one of all the symbols.

According to a twelfth aspect of the invention, there is provided a control method of a gaming machine comprising the steps of: controlling a first display to variably display and then to stop a plurality of symbols in a first game; determining a winning of the first game in accordance with the symbols stopped in the first display; controlling a second display to display an image that a ball is received in any of a plurality of receivers which correspond to the respective areas, in a second game different from the first game; controlling the first display so that a symbol in an area corresponding to a receiver in which the ball is received is displayed in a special form, in the first game; transmitting a data item relating to the receiver in which the ball is received to a host computer that manages a plurality of gaming machines including the gaming machine and divides them into groups which correspond to the receivers, respectively; and receiving a payout data item about a special payout from the host computer and performing a special payout based on the payout data item, when the gaming machine belongs to a group corresponding to the receiver based on the data item relating to the receiver.

According to a thirteenth aspect of the invention, there is provided a control method of a gaming machine comprising the steps of: controlling a first display to variably display and then to stop a plurality of symbols in a first game; determining a winning of the first game in accordance with the symbols stopped in the first display; controlling a second display to display an image that a ball is received in any of a plurality of receivers which correspond to the respective areas, in a second game different from the first game; controlling the first display so that a special symbol is fixedly displayed in an area corresponding to a receiver in which the ball is received, while the symbols are variably displayed and stopped in the first game, the special symbol being replaceable with any one of all the symbols; and changing a payout number relating to a winning in accordance with the special symbol fixedly displayed.

According to a fourteenth aspect of the invention, there is provided a control method of a gaming machine comprising the steps of: controlling a first display to variably display and then to stop a plurality of symbols in a first game; determining a winning of the first game in accordance with the symbols stopped in the first display; controlling a second display to display an image that a ball is received in any of a plurality of receivers which correspond to the respective areas, in a second game different from the first game; controlling the first display so that a symbol in an area corresponding to a receiver in which the ball is received is displayed in a special form, in the first game; changing a payout number relating to a winning in accordance with the special form; transmitting a data item relating to the receiver in which the ball is received to a host computer that manages a plurality of gaming machines including the gaming machine and divides them into groups which correspond to the receivers, respectively; and receiving a payout data item about a special payout from the host computer and performing a special payout based on the payout data item, when the gaming machine belongs to a group corresponding to the receiver based on the data item relating to the receiver.

According to a fifteenth aspect of the invention, there is provided a control method of a gaming machine comprising the steps of: controlling a first display to variably display and then to stop a plurality of symbols in a first game; determining a winning of the first game in accordance with the symbols stopped in the first display; controlling a second display to display an image that a ball is received in any of a plurality of receivers which correspond to the respective areas, in a second game different from the first game; controlling the first display so that a special symbol is fixedly displayed in an area corresponding to a receiver in which the ball is received, while the symbols are variably displayed and stopped in the first game, the special symbol being replaceable with any one of all the symbols; transmitting a data item relating to the receiver in which the ball is received to a host computer that manages a plurality of gaming machines including the gaming machine and divides them into groups which correspond to the receivers, respectively; and receiving a payout data item about a special payout from the host computer and performing a special payout based on the payout data item, when the gaming machine belongs to a group corresponding to the receiver based on the data item relating to the receiver.

According to a sixteenth aspect of the invention, there is provided a control method of a gaming machine comprising the steps of: controlling a first display to variably display and then to stop a plurality of symbols in a first game; determining a winning of the first game in accordance with the symbols stopped in the first display; controlling a second display to display an image that a ball is received in any of a plurality of receivers which correspond to the respective areas, in a second game different from the first game; controlling the first display so that a special symbol is fixedly displayed in an area corresponding to a receiver in which the ball is received, while the symbols are variably displayed and stopped in the first game, the special symbol being replaceable with any one of all the symbols; changing a payout number relating to a winning in accordance with the special symbol fixedly displayed; transmitting a data item relating to the receiver in which the ball is received to a host computer that manages a plurality of gaming machines including the gaming machine and divides them into groups which correspond to the receivers, respectively; and receiving a payout data item about a special payout from the host computer and performing a special payout based on the payout data item, when the gaming machine belongs to a group corresponding to the receiver based on the data item relating to the receiver.

In the above first to sixteenth aspects, a result of a second game influences on a first game. Thereby, a new entertainment characteristic is provided to a player. To be more specific, in the first, second, fourth, sixth, ninth, tenth, twelfth and fourteenth aspects, a symbol in an area corresponding to a receiver in which a ball is received is displayed in a special form, so that a winning probability of the first game is increased or decreased. In the third, fifth, seventh, eighth, eleventh, thirteenth, fifteenth and sixteenth aspects, a special symbol is fixedly displayed in an area corresponding to a receiver in which a ball is received, so that a winning probability of the first game is increased. In addition, in the second, fifth, sixth, eighth, tenth, thirteenth, fourteenth and sixteenth aspects, a payout number relating to a winning is increased or decreased in accordance with the special form or the special symbol fixedly displayed. Furthermore, in the fourth, sixth, seventh, eighth, twelfth, fourteenth, fifteenth and sixteenth aspects, a benefit called as a special payout may be provided.

### BRIEF DESCRIPTION OF THE DRAWINGS

Other and further objects, features and advantages of the invention will appear more fully from the following description taken in connection with the accompanying drawings, in which:

FIG. 1 is a schematic view showing that gaming machines according to an embodiment of the invention are connected in communication with a host computer;

FIG. 2 shows a perspective view showing an external appearance of a gaming machine according to an embodiment of the invention;

FIG. 3 shows an example of an image that is displayed in a center display of the gaming machine in a base game;

FIG. 4 shows a data table of symbols depicted on each display window;

FIG. 5 and FIG. 6 show examples of an effect image that is displayed in each of a center display and an upper display of the gaming machine in a bonus game;

FIG. 7 and FIG. 8 are block diagrams showing an electrical structure of the gaming machine;

FIG. 9 shows a payout table;

FIG. 10 is a flow chart showing a game process that is executed by the gaming machine; and

FIG. 11 is a flow chart showing a bonus game process that is executed by the gaming machine.

FIG. 12 is a flow chart showing an effect process that is performed during a bonus game;

FIG. 13 is a flow chart showing a special payout process that is performed by the gaming machine;

FIG. 14 is a flow chart showing a WILD symbol display process that is performed by the gaming machine; and

FIG. 15 is a flow chart showing a payout data transmit process that is performed by a host computer.

### DESCRIPTION OF THE PREFERRED EMBODIMENTS

Hereinafter, it will be described an embodiment of a gaming machine according to the invention with reference to the drawings.

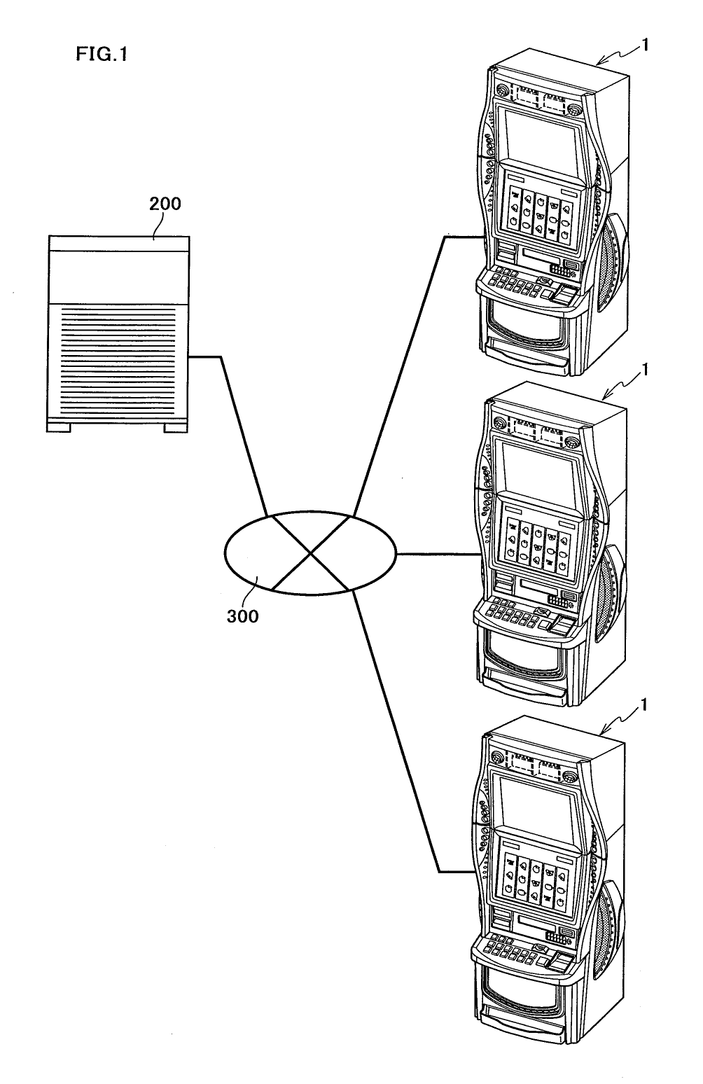

As shown in FIG. 1, gaming machines 1 according to an embodiment of the invention are equipped in a game arcade such as casino, and connected in communication with a host computer 200 via an internet network 300, respectively. Each of the gaming machines 1 provides a player with a base game and a bonus game that is more advantageous to the player than the base game. As described below, in a bonus game, a sub game using the symbols same as in a base game is executed one or several times and an effect process, which will be described later, is executed whenever the sub game is executed three times.

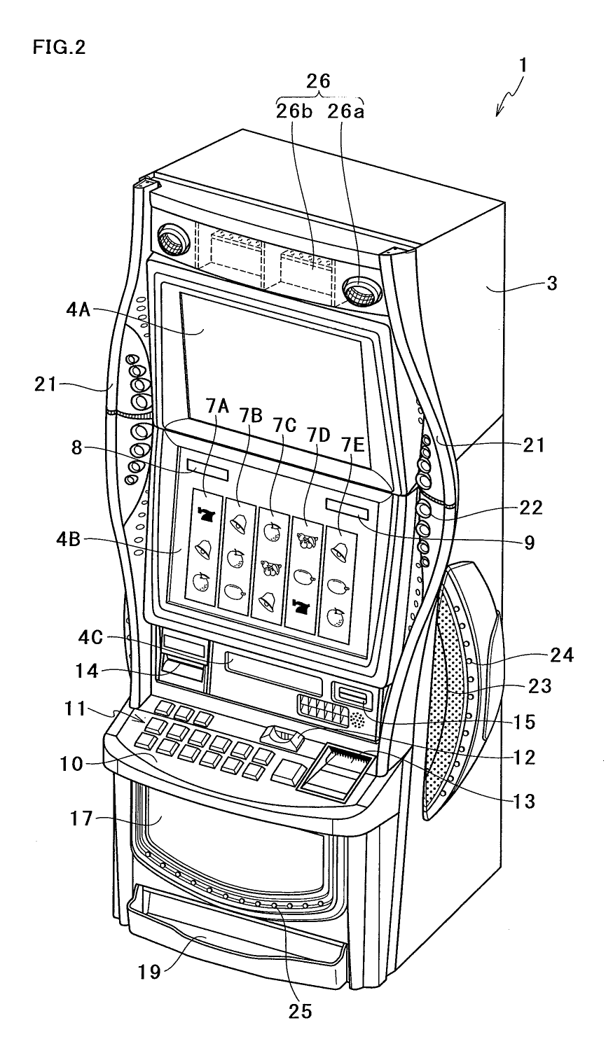

As shown in FIG. 2, the gaming machine 1 has a cabinet 3 that is longitudinally long. To a front face of the cabinet are provided an upper display 4A, a center display 4B and a sub display 4C.

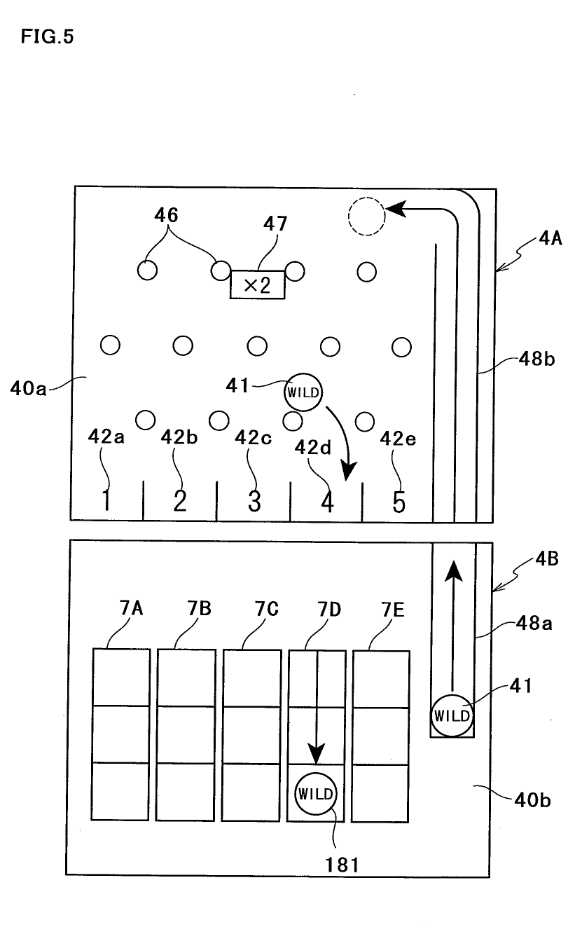

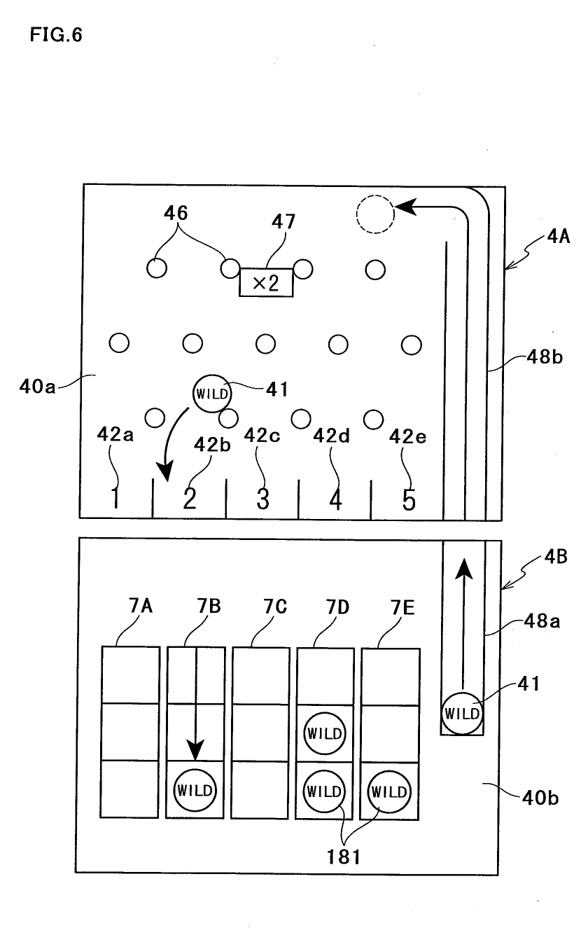

The upper display 4A has a transparent liquid crystal panel fixed to a front door of the cabinet 3 and displays an upper effect image 40a (refer to FIGS. 5 and 6) in an effect process that is performed during a bonus game, which will be described later.

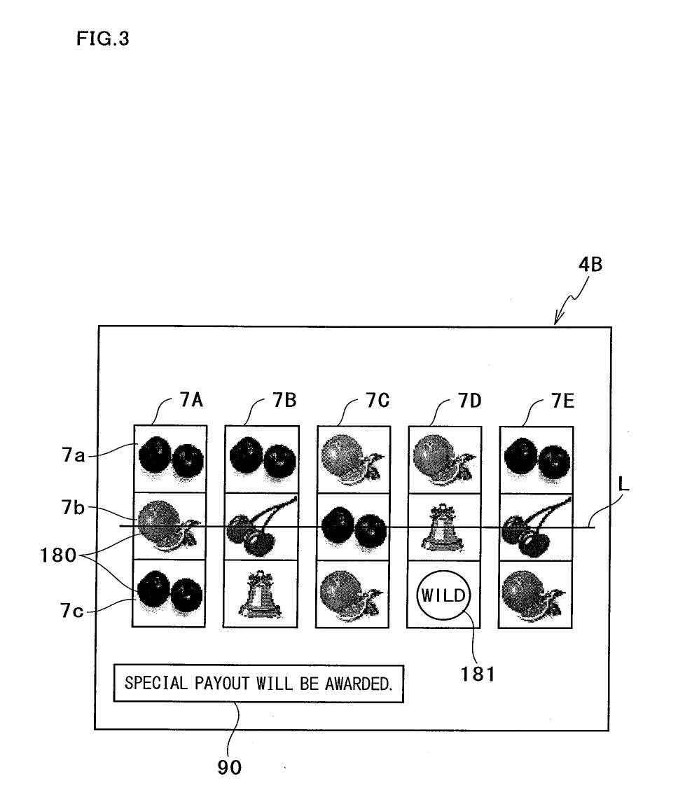

The center display 4B also has a transparent liquid crystal panel that is fixed to the front door of the cabinet 3. In a base game, the center display 4B performs a display as shown in FIGS. 2 and 3. To be more specific, as shown in FIG. 3, the center display 4B is provided with five transparent display windows 7A, 7B, 7C, 7D, 7E. A player plays a base game while seeing that the symbols 180 are scrolled in each of the display windows 7A to 7E. Each of the display windows 7A to 7E is divided into an upper stage 7a, a central stage 7b and a lower stage 7c. At the time when the scroll display is ended in the base game, the symbols 180 are stopped in the respective upper stage 7a, central stage 7b and lower stage 7c. Accordingly, the display windows 7A to 7E display the symbols 180 in a matrix type of 5 colums/3 rows. For example, in FIG. 3, “PLUM” is stopped in the upper stage 7a of the display window 7A, “ORANGE” is stopped in the central stage 7b of the display window 7A and “PLUM” is stopped in the lower stage 7c of the display window 7A.

A payline L is provided which horizontally traverses the central stages 7b of the display windows 7A to 7E. A winning is determined depending on a combination of the symbols 180 stopped on the payline L. When a winning is made, a payout is awarded or a game state is shifted to a bonus game, in accordance with a combination of the symbols 180 on the payline L. The “payout” means awarding a game medium to a player. The game medium may include the credits to be stored in the gaming machine 1, in addition to a coin. In payment, a credit-number relating to a combination of the symbols is added to a current credit-number or a predetermined number of coins is discharged to a coin tray 19 that will be described later.

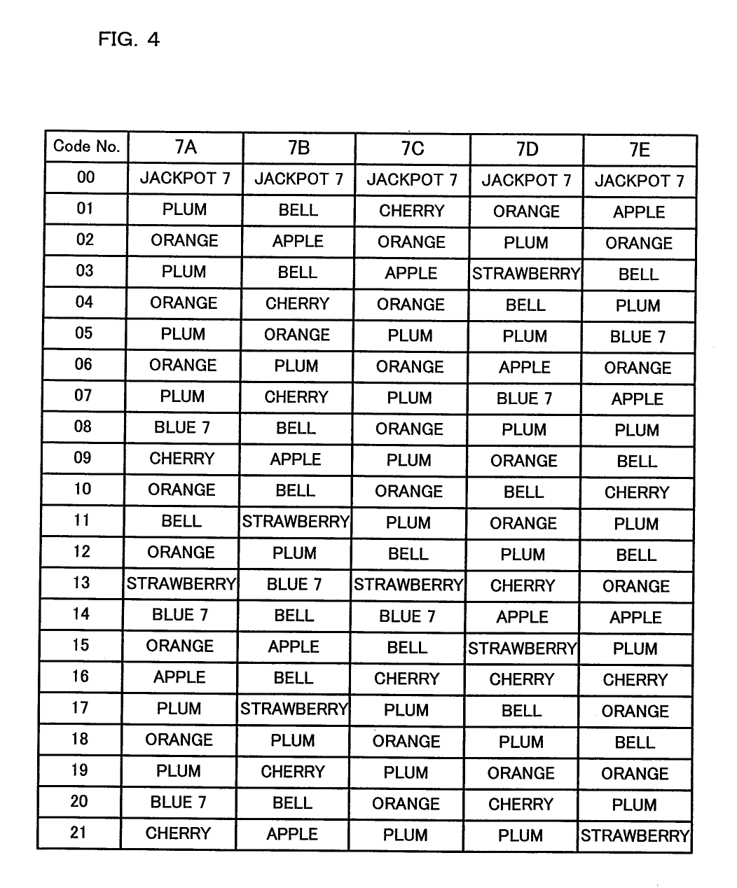

The symbols 180 include eight types of “JACKPOT 7,” “BLUE 7,” “BELL,” “CHERRY,” “STRAWBERRY,” “PLUM,” “ORANGE” and “APPLE.” As shown in FIG. 4, 22 symbols 180, which are combined in different orders, are sequentially displayed in each of the display windows 7A to 7E. The symbols 180 are given with code numbers of 0 to 21 in an order.

For example, when a symbol of “APPLE” is arranged on the payline L, the game state is shifted to a bonus game. When a symbol of “CHERRY” is arranged on the payline L, 20 coins are paid out per one bet. When a symbol of “PLUM” is arranged on the payline L, 5 coins are paid out per one bet.

Back to FIG. 2, a payout-number indicator 8 and a credit-number indicator 9 are disposed above the display windows 7A to 7E in the center display 4B. The center display 4B also displays a moving picture to carry out an effect when a winning is made.

The center display 4B displays a central effect image 40b (refer to FIGS. 5 and 6) in an effect process that is performed during a bonus game. In an effect process in a bonus game, a player sees an upper effect image 40a displayed in the upper display 4A and a central effect image 40b displayed in the center display 4B.

Here, examples of the effect images 40a, 40b will be described with reference to FIGS. 5 and 6.

Pins 46 arranged at a predetermined distance, five receivers 42a, 42b, 42c, 42d, 42e, a gate 47 and a second passage 48b through which a ball 41 passes are displayed in the upper effect image 40a. A first passage 48b through which the ball 41 passes is displayed in the central effect image 40b in addition to the display windows 7A to 7E. The receivers 42a to 42e correspond to the display window 7A to 7E, respectively.

The ball 41 is a same display form as a WILD symbol 181. The WILD symbol 181 is a special symbol that is displayed in a bonus game only and can be replaced with any of the symbols 180. For example, the WILD symbol 181 can be considered as a symbol of “PLUM” or “ORANGE”.

The gaming machines 1, which are managed by the host computer 200, are divided into five groups. The receiver 42a, the receiver 42b, the receiver 42c, the receiver 42d and the receiver 42e correspond to a first group, a second group, a third group, a fourth group and a fifth group, respectively.

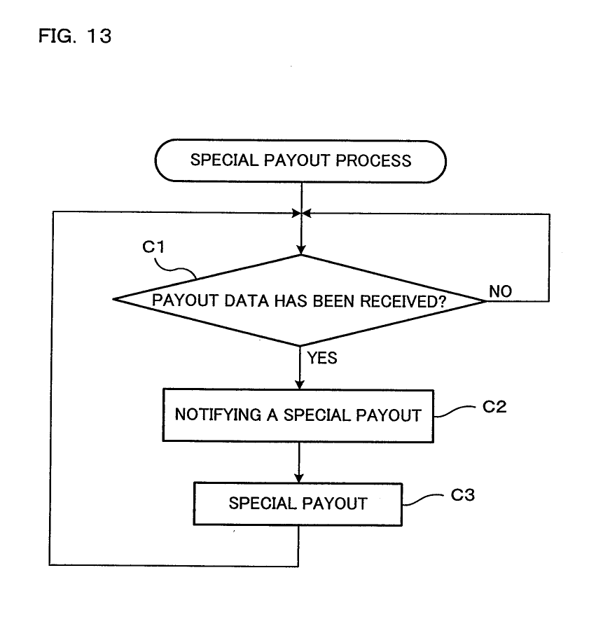

When an effect process is started in a bonus game, the ball 41 is shot upwards in the central effect image 40b. The ball 41 passes through the first passage 48a. When the ball reaches a top of the passage 48a, the ball disappears from the central effect image 40b and moves to the second passage 48b of the upper effect image 40b. Then, the ball passes through the second passage 48b, is throw away left from an exit of the passage 48b, and is dropped while colliding with the pins 46 and thus changing a direction. When the ball 41 passes through the gate 47, the number of the ball 41 is doubled and becomes two. When the ball 41 is received in any one of the receivers 42a to 42e, the WILD symbol 181 is sequentially displayed from a lower stage of the corresponding display window. The WILD symbol 180 is fixedly displayed at a corresponding location in a sub game that is performed after an effect process and is erased when the bonus game ends. In addition, as described below with reference to FIG. 13, a gaming machine 1, which belongs to a group corresponding to the receivers 42a to 42e in which the ball 41 is received, performs a special payout.

FIG. 5 shows an example in which when the ball 41 is received in the receiver 42d without passing through the gate 47, the WILD symbol 181 is displayed in a lower stage of the display window 7D corresponding to the receiver 42d. FIG. 6 shows an example in which the two balls 41 are received in the receiver 42d and the one ball 41 has been received in the receiver 42e, so that the WILD symbol 181 has been already displayed in the lower and central stages of the display window 7D and the lower stage of the display window 7E, and the ball 41 is received in the receiver 42b without passing through the gate 47, so that the WILD symbol 181 is displayed in the lower stage of the display window 7B corresponding to the receiver 42b.

Again referring to FIG. 2, a card reader 15 is provided to a right side of the sub display 4C. The card reader 15 reads the data from a smart card possessed by a player, or writes the data to the smart card. The sub display 4C displays the credit-number read by the card reader 15, the summed credit-number obtained by adding the credit-number acquired in a game to the corresponding credit-number, and the like. The “credit-number acquired in a game” corresponds to an amount of money that is paid out based on a display result of the center display 4B. For example, when a combination of the symbols about a winning is displayed in the center display 4B in a base game, the credit-number resulting from the combination of the symbols is added to the current credit-number. A ticket printer 14 that prints the current credit-number and the like onto a ticket is provided to a left side of the sub display 4C.

A control panel 10 that forward protrudes from the front of the cabinet 3 is provided below the sub display 4C. On the control panel 10 is arranged a button group 11 including a BET button, a start button, and the like. The BET button is pushed in betting, and the start button is pushed in starting a game. In addition, the control panel 10 is provided with a coin insertion slot 12 and a bill insertion slot 13.

In the front of the cabinet 3, a sub-panel 17 is provided below the control panel 10. The sub-panel 17 is a plastic panel having a game-related image printed thereto and is outward illuminated by a cold cathode tube. A coin tray 19 that receives the coins discharged is disposed below the sub-panel 17.

In the front of the cabinet 3, protrusions 21 that are outward protruded in a bow shape are formed at both sides of the upper display 4A and the center display 4B. Side lamps 22 are arranged at the respective protrusions 21. The cabinet 3 is provided at both sides thereof with speakers 23 so that they protrude in an arc shape. Speaker lamps 24 are arranged along edges of the speakers 23. Under lamps 25 are arranged along a lower edge of the sub-panel 17. To an upper part of the upper display 4A are provided top lamps 26 including a pair of right and left lamps 26a and band-shaped lamps 26 that are horizontally arranged between the power lamps 26a.

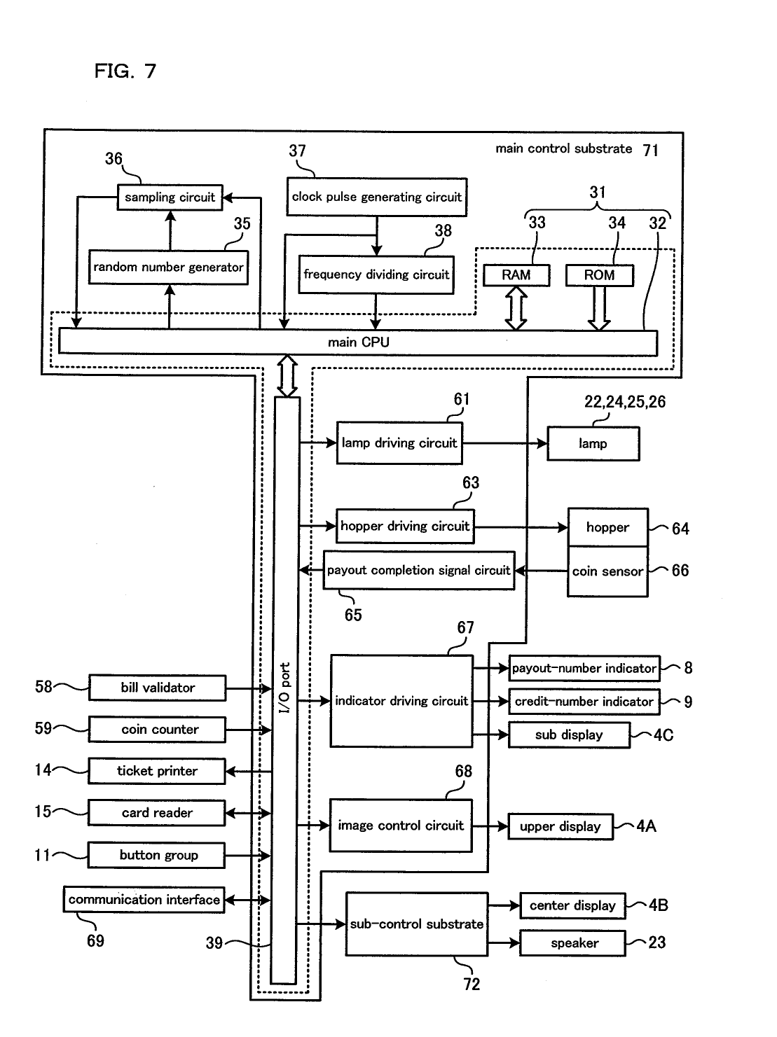

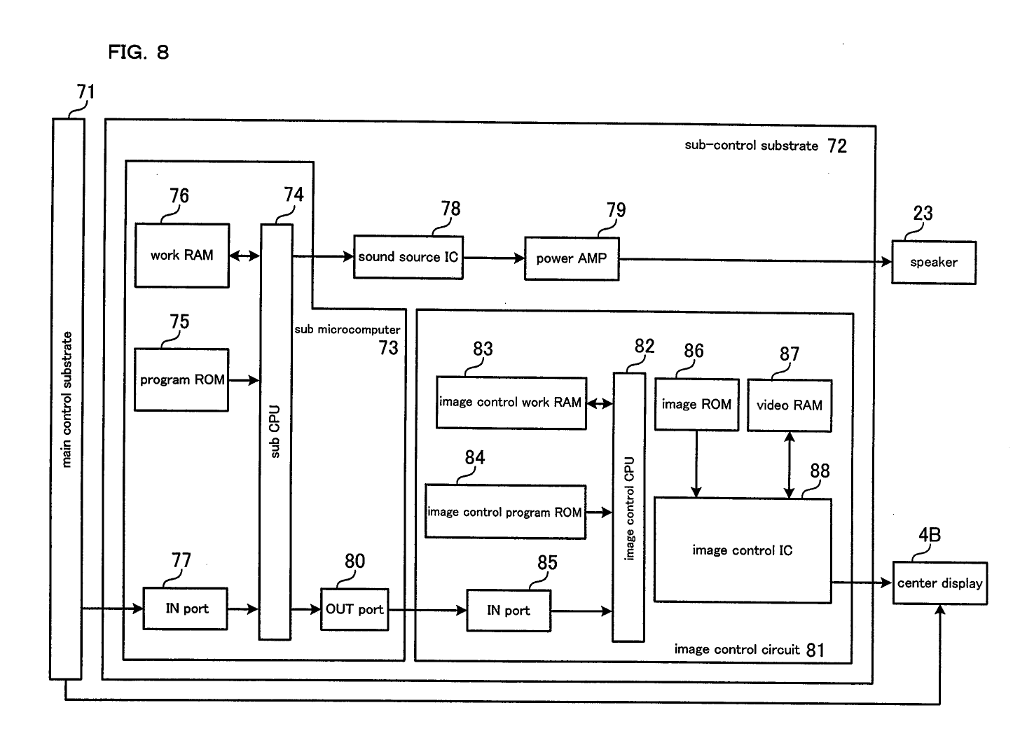

In the followings, an electrical structure of the gaming machine 1 will be described with reference to FIGS. 7 and 8. As shown in FIG. 7, the gaming machine 1 comprises a main control substrate 71. The main control substrate 71 comprises a microcomputer 71, a random number generator 35, a sampling circuit 36, a clock pulse generating circuit 37, a frequency dividing circuit 38, a lamp driving circuit 61, a hopper driving circuit 63, a payout completion signal circuit 65, an indicator driving circuit 67 and an image control circuit 68.

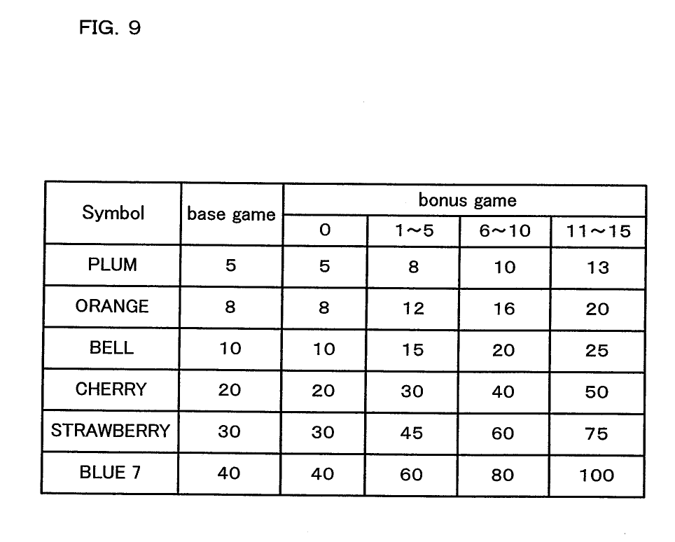

The microcomputer 31 has a main CPU 32, a RAM 33 and a ROM 34. The main CPU 32 operates in accordance with a program stored in the ROM 34 and executes an input/output of a signal to and from the other components through an I/O port 39, thereby controlling an overall operation of the gaming machine 1. The RAM 34 stores data of the symbols 180 including the code numbers, data or program that is used when the main CPU 32 operates, and the like. For example, after a game starts, the RAM 33 temporarily maintains a random number that is sampled by the sampling circuit 36. In addition, the RAM 33 stores a payout table shown in FIG. 9. The ROM 34 stores a program that is executed by the main CPU 32, permanent data and the like.

The random number generator 35 operates and generates a random number within a predetermined range, in accordance with an instruction of the main CPU 32. The sampling circuit 36 samples any random number of the random numbers that are generated by the random number generator 35 and inputs the sampled random number into the main CPU 32, in accordance with an instruction of the main CPU 32. The clock pulse generating circuit 37 generates a reference clock for operating the main CPU 32. The frequency dividing circuit 38 inputs a signal, which the reference clock is divided in a predetermined period, to the main CPU 32.

The main control substrate 71 is connected with the button group 11. A signal corresponding to the push of each button included in the button group 11 is inputted into the main CPU 32 via the I/O port 39.

In addition, the main control substrate 71 is connected with a bill validator 58, a coin counter 59, a ticket printer 14, a card reader 15 and a communication interface 69.

The bill validator 58 reads an image of bill inserted into the bill insertion slot 13 and receives the normal bill in the cabinet 3. When receiving the normal bill, the bill validator 58 inputs a signal to the main CPU 32 based on an amount of the bill. The main CPU 32 having received the signal stores a credit-number in the RAM 33, which corresponds to the amount of bill.

The coin counter 59 is provided in the coin insertion slot 12 and identifies whether the coin inserted into the coin insertion slot 12 by a player is normal or not. The abnormal coin is discharged to the coin tray 19. In addition, the coin counter 59 inputs a signal to the main CPU 32 when it detects a normal coin.

The ticket printer 14 prints a barcode on a ticket, in which data stored in the RAM 33 such as credit-number, the day and time, the identification number of the gaming machine 1 and the like is coded, and outputs a ticket having the barcode attached thereto.

The card reader 15 reads the data from a smart card possessed by a player to transmit it to the main CPU 32, or writes the data to the smart card based on a control signal from the main CPU 32.

The communication interface 69 communicates with the host computer 200.

The lamp driving circuit 61 outputs a lighting-on or lighting-off signal to the lamps 22, 24, 25, 26 so as to perform an illumination effect.

The hopper driving circuit 63 drives a hopper 64 under control of the main CPU 32. The hopper 64 operates to discharge a coin to the coin tray 19. The payout completion signal circuit 65 is connected with the coin sensor 66. The coin sensor 66 counts the coins that are discharged as the hopper 64 is driven, thereby inputting count data to the payout completion signal circuit 65. The payout completion signal circuit 65 inputs a payout completion signal to the main CPU 32 when the discharged coin-number reaches a predetermined number, based on the count data from the coin sensor 66. The indicator driving circuit 67 controls the display operations of the payout-number indicator 8, the credit-number indicator 9 and the sub display 4C.

The image control circuit 68 controls the upper display 4A to display the upper effect image 40a in an effect process that is performed during a bonus game. The image control circuit 68 has an approximately same structure as an image control circuit 81 (refer to FIG. 8) included in a sub-control substrate 72.

Further, the main control substrate 71 is connected with a sub-control substrate 71. In a base game, the sub-control substrate 72 controls the display of the center display 4B and the voice output of the speakers 23. As shown in FIG. 8, the sub-control substrate 71 is a separate substrate from the main control substrate 71 and comprises a sub microcomputer 73, a sound source IC 78, a power AMP 79 serving as an amplifier and an image control circuit 81. The sound source IC 78 controls a voice sound outputted from the speakers 23. The image control circuit 81 controls the display of the center display 4B.

The sub microcomputer 73 has a sub CPU 74, a program ROM 75, a work RAM 76, an IN port 77 and an OUT port 80. The sub CPU 74 performs a control operation in accordance with a control command transmitted from the main control substrate 71. Although the sub-control substrate 72 does not have a clock pulse generating circuit, a frequency dividing circuit, a random number generator and a sampling circuit, the sub CPU 74 executes a random number sampling on the operating program. The program ROM 76 stores a control program that is executed by the sub CPU 74. The work RAM 76 temporarily stores the data when the sub CPU 74 executes the control program.

The image control circuit 81 has an image control CPU 82, an image control work RAM 83, an image control program ROM 84, an IN port 85, an image ROM 86, a video RAM 87 and an image control IC 88. The image control CPU 82 determines an image that is displayed in the center display 4B in a base game, in accordance with the image control program stored in the image control program ROM 84, based on a parameter that is set by the sub microcomputer 73.

The image control program ROM 84 stores an image control program that is related to a display in the center display 4B, or various selection tables. The image control work RAM 83 temporarily stores the data when the image control CPU 82 executes the image control program. The image control IC 88 forms an image that is determined by the image control CPU 82 and outputs it to the center display 4B.

The image ROM 86 stores dot data for forming an image. The video RAM 87 temporarily stores the data when the image control IC 88 forms the image data.

Although not shown, the host computer 200 has a CPU, a ROM, a RAM, a communication interface and the like.

In the followings, a payout table will be described with reference to FIG. 9. A payout table is stored in the RAM 33 of the main control substrate 71. In the payout table, payouts depending on types of the symbols arranged on the payline L are set for each of a base game and a bonus game. In addition, in a bonus game, the payouts are set in accordance with the number of the WILD symbols 181. In a base game and a bonus game, even when the same symbols are arranged on the payline L, the payouts may be different. For example, in a case where a symbol of “BELL” is arranged on the payline L, 10 is paid out in a base game, and in a bonus game, 10 and 20 are respectively paid out when the number of the WILD symbol 181 is 0 and when the number of the WILD symbol 181 is 6 to 10. In a bonus game, the payout to be awarded when the number of the WILDA symbol 181 is 0 is same as in the base game. The more the number of the WILD symbol 181, the more payouts.

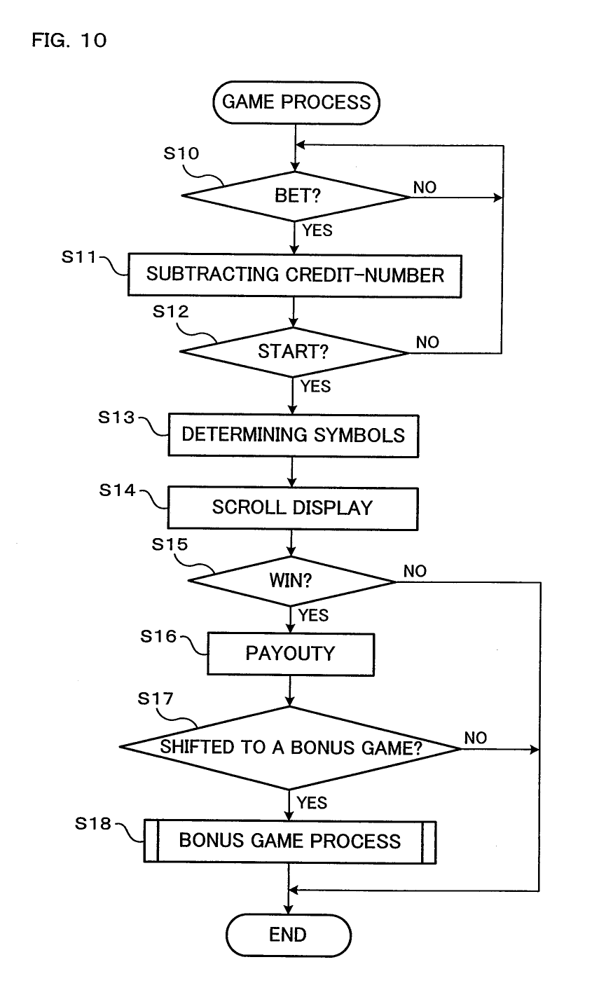

In the followings, a game process that is executed by the gaming machine 1 will be described with reference to FIG. 10. When the main CPU 32 reads out a game program stored in the ROM 34, a game process is progressed.

Firstly, the main CPU 32 determines whether a bet is made, based on whether it receives a signal accompanying with the push of the BET button (S10). When a bet is not made (S10, NO), the process of S10 is repeated. In other words, the main CPU stands by until a bet is made.

When a bet is made (S10, YES), the main CPU 32 subtracts the credit-number stored in the RAM 33 by the amount of money bet (S11). When the amount of money bet is larger than the credit-number stored in the RAM 33, or when the amount of money bet exceeds an upper limit capable of being bet in one game, i.e., maximum betting amount of money, the main CPU proceeds to a step of S12 without the step of S11 of subtracting the credit-number. In this embodiment, the maximum betting amount of money is 50.

Then, the main CPU 32 determines whether to start a game, based on whether a signal accompanying with the push of the start button is received (S12). When the start button is not pushed (S12, NO), the process is returned to the step of S10. For example, when the start button is not pushed and an instruction to end the game is inputted, the subtraction process of S10 is canceled.

When the start button is pushed (S12, YES), the main CPU 32 executes the symbol determining program stored in the ROM 34, thereby determining the symbols 180 to be stopped after the scroll display in the display windows 7A to 7E (S13).

Then, the main CPU 32 controls the center display 4B so that the symbols 180 are scroll-displayed in the display windows 7A to 7E (S14). The main CPU 32 controls the center display 4B so that the symbols determined in the step of S13 are stopped in the display windows 7A to 7E.

Then, the main CPU 32 determines whether a winning is made, based on whether a combination of the symbols stopped on the payline L is a predetermined combination (S15). When a winning is not made (S15, NO), this routine is ended. When a winning is made (S15, YES), a payout is awarded which corresponds to the combination of the symbols stopped on the payline L, based on the payout table shown in FIG. 9 (S16).

Then, the main CPU 32 determines whether to shift the game state to a bonus game (S17). In this embodiment, when a symbol of “APPLE” is arranged on the payline L, the game state is shifted to a bonus game. When it is determined not to shift the game state to a bonus game (S17, NO), this routine is ended. When it is determined to shift the game state to a bonus game (S17, YES), a bonus game process is executed which will be described later (S18). The main CPU 32 ends this routine after executing the bonus game process.

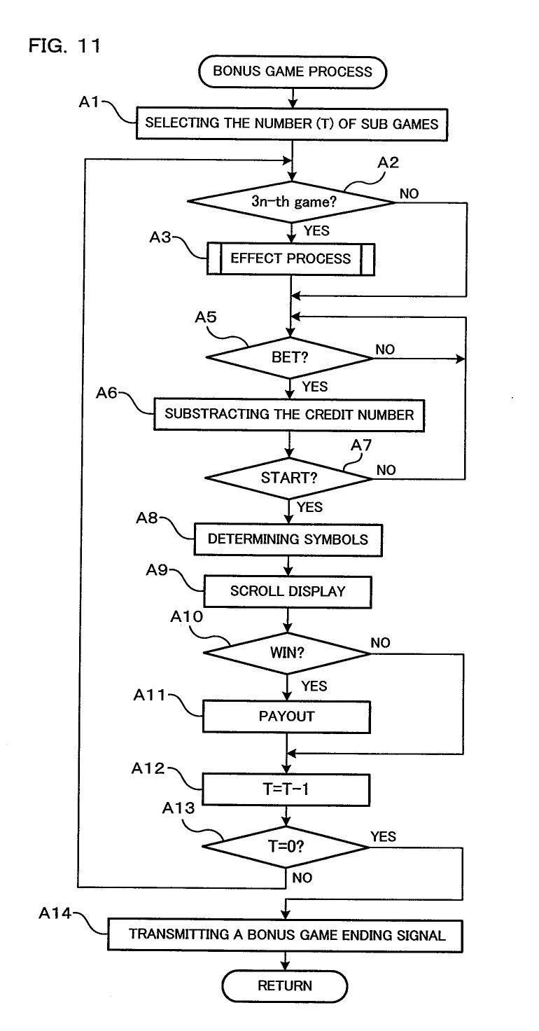

In the followings, a bonus game process that is executed by the gaming machine 1 will be described with reference to FIG. 11.

Firstly, the main CPU 32 determines the number (T) of the sub games to be executed in a bonus game (A1). The sub game is same as a base game and means such a series of operations that the symbols 180 are scroll-displayed in the display windows 7A to 7E and a payout depending on a combination of the symbols stopped on the payline L is awarded. Therefore, processes of A5, A6, A7, A8, A9, A10 and A11 described below are approximately same as those of S10, S11, S12, S13, S14, S15 and S16 in FIG. 10.

After the process of A1, the main CPU 32 determines whether a sub game, which will be performed from now, is a 3n-th game (n: natural number) (A2). When the sub game is a 3n-th game (A2: YES), an effect process that will be described later is executed (A3).

When the sub game is not a 3n-th game (A2: NO) or after the process of A3, the main CPU 32 determines whether a bet is made or not (A5). When a bet is not made (A5: NO), the process of A5 is repeated. In other words, the main CPU waits until a bet is made. When a bet is mage (A5: YES), the main CPU subtracts the credit-number stored in the RAM 33 by the bet number (A6). When the amount of money bet is larger than the credit-number stored in the RAM 33, or when the amount of money bet exceeds an upper limit capable of being bet in one game, i.e., maximum betting amount of money, the main CPU proceeds to a step of A7 without the step of A6 of subtracting the credit-number.

Then, the main CPU 32 determines whether to start a sub game, based on whether a signal accompanying with the push of the start button is received (A7). When the start button is not pushed (A7, NO), the process is returned to the step of A5. For example, when the start button is not pushed and an instruction to end the game is inputted, the subtraction process of A6 is canceled.

When the start button is pushed (A7, YES), the main CPU 32 executes the symbol determining program stored in the ROM 34, thereby determining the symbols 180 to be stopped after the scroll display in the display windows 7A to 7E (A8).

Then, the main CPU 32 controls the center display 4B so that the symbols 180 are scroll-displayed in the display windows 7A to 7E (A9). The main CPU 32 controls the center display 4B so that the symbols determined in the step of A8 are stopped in the display windows 7A to 7E. At this time, the WILD symbol 181 displayed due to the effect process of A3 is as it is displayed at corresponding locations in the display windows 7A to 7E.

Then, the main CPU 32 determines whether a winning is made, based on whether a combination of the symbols stopped on the payline L is a predetermined combination (A10). At this time, when the WILD symbol 181 is displayed on the payline L, a winning probability is increased. When a win is made (A10: YES), a payout based on the payout table shown in FIG. 9 is awarded (A11). The payout is determined in accordance with the symbol relating to a win and the number of the WILD symbol 181.

When a win is not made (A10: NO), or after the process of A11, the main CPU 32 subtracts the number (T) of the sub game by “1” (A12). Then, the main CPU determines whether the number (T) of sub game is “0” or not (A13). When the number (T) is not “0” (A13: NO), the process is returned to A2. When the number (T) is “0” (A13: YES), the main CPU 32 transmits a bonus game ending signal to the sub control substrate 71 (A14). Then, this sub routine is ended.

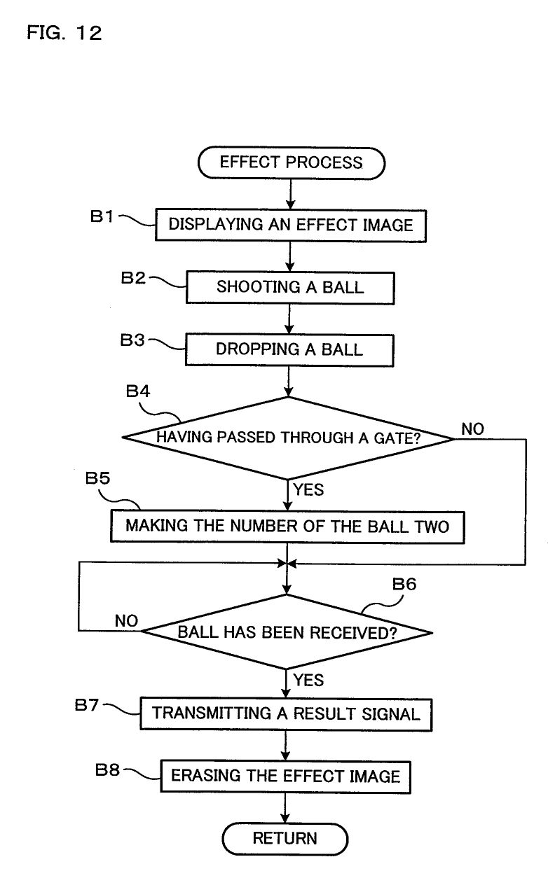

In the followings, an effect process that is performed in A3 will be described with reference to FIG. 12.

Firstly, the main CPU 32 determines the upper display 4A and the center display 4B so that the upper effect image 40a and the central effect image 40b are displayed (B1). Then, the main CPU 32 controls the center display 4B so that the ball 41 is shot upward in the central effect image 40b (B2). The shot ball 41 passes through the first passage 48a and moves to the second passage 48b of the upper effect image 40b.

Then, the main CPU 32 controls the upper display 4A so that the ball 41 is thrown away left from the exit of the second passage 48b (B3). Then, the main CPU 32 determines whether the ball 41 has passed through the gate 47 (B4). When the ball 41 has passed through the gate 47 (B4: YES), the main CPU makes the number of the ball 41 double, i.e., two (B5).

When the ball 41 has not passed through the gate 47 (B4: NO), or after the process of B5, the main CPU 32 determines whether one or two balls 41 have been received in any one of the receivers 42a to 42e (B6). When one or two balls 41 are not received in any one of the receivers 42a to 42e (B6: NO), the process of B6 is repeated. In other words, the main CPU waits until one or two balls 41 are received in any one of the receivers 42a to 42e. When one or two balls 41 are received in any one of the receivers 42a to 42e (B6: YES), the main CPU 32 transmits to the sub CPU 74 of the sub control substrate 72 and the host computer 200 a signal relating to a result of the receiver in which the ball 41 is received (B7). Then, the main CPU 32 controls the upper display 4A and the center display 4B so that the upper effect image 40a and the central effect image 40b are erased (B8). Then, this sub routine is ended.

The main CPU 32 further executes a special payout process shown in FIG. 13.

Firstly, the main CPU 32 determines whether it receives payout data of a special payout from the host computer 200 (C1). When the data is not received (C1: NO), the process of C1 is repeated. In other words, the main CPU waits until the payout data is received. When the data is received (C1: YES), the main CPU 32 controls the sub substrate 72 so that a message indicating that a special payout will be awarded is notified in the center display 4B, as shown in FIG. 3 (C2). Then, the main CPU awards a special payout based on the payout data received (C3).

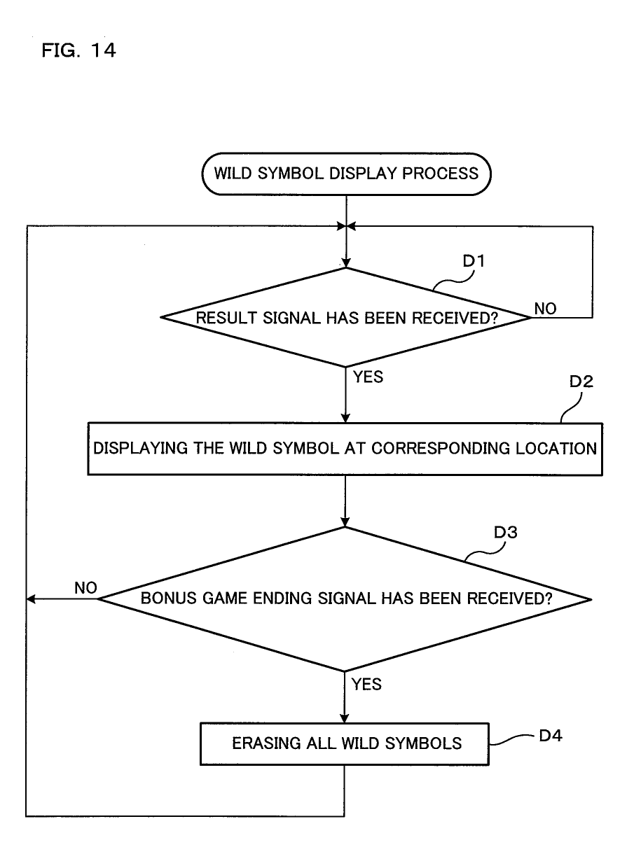

The sub CPU 74 of the gaming machine 1 executes a WILD symbol display process shown in FIG. 14.

Firstly, the sub CPU 74 determines whether it has received the result signal transmitted from the main CPU 32 in the B7 of the effect process (refer to FIG. 12) (D1). When the signal is not received (D1: NO), the process of D1 is repeated. In other words, the sub CPU waits until the result signal is received. When the signal is received (D1: YES), the sub CPU 74 controls the center display 4B so that a WILD symbol 181 is displayed in the display window corresponding to the receiver, based on the result signal (D2). Here, as described above, the WILD symbol 181 is arranged in an order of lower, central and upper stages of the display window.

Then, the sub CPU 74 determines whether it has received a bonus game ending signal transmitted from the main CPU 32 in the A14 of the bonus game process (D3). When the signal is not received (D3: NO), the process is returned to the D1. When the signal is received (D3: YES), the sub CPU 74 controls the center display 4B so that all the WILD symbols 181, which are currently displayed in the display windows, are erased (D4). Then, the process is returned to the D1.

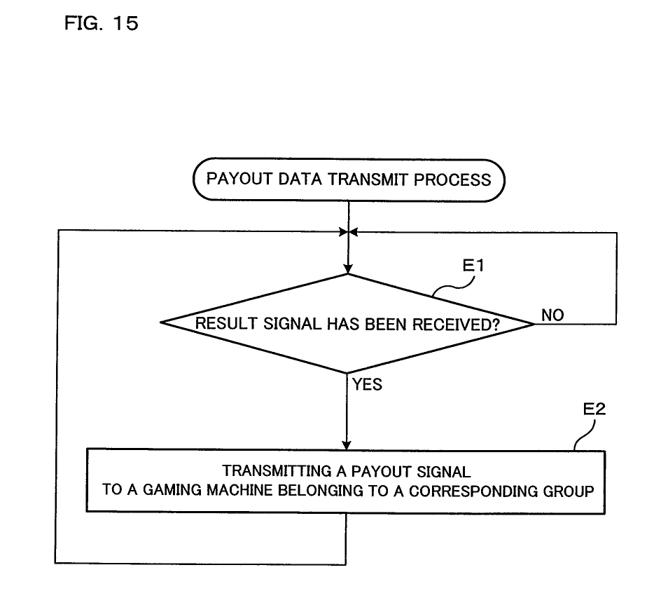

The CPU of the host computer 200 executes a payout data transmit process shown in FIG. 15.

Firstly, the CPU of the host computer 200 determines whether it has received the result signal transmitted from the main CPU 32 of the gaming machine 1 in the B7 of the effect process (refer to FIG. 12) (E1). When the signal is not received (E1: NO), the process of E1 is repeated. In other words, the CPU waits until the signal is received. When the signal is received (E1: YES), the CPU of the host computer 200 transmits the payout data of a special payout to each of the gaming machines 1 belonging to the group corresponding to the receivers, based on the result signal (E2). Then, the process is returned to the E1.

As described above, according to this embodiment, in a bonus game, a result of an effect process influences on a sub game. Thereby, a new entertainment characteristic is provided to a player. To be more specific, the WILD symbol 181 is fixedly displayed in a display window corresponding to a receiver in which the ball 41 is received in an effect process. That is, after the WILD symbol 181 is displayed at a location corresponding to the display window, the WILD symbol 181 is stopped at the location while the scroll display of symbols is performed. Thus, a winning probability is increased. In addition, a payout, which is awarded when a win is made, is increased when the number of the WILD symbol 181 is increased. Moreover, the gaming machine 1 belonging to a group corresponding to the receivers 42a to 42e in which the balls 41 are received performs a special payout. Therefore, a player can play a game with more interests in the game.

In the mean time, a special symbol, which is fixedly displayed in a display window corresponding to a receiver in which the ball 41 is received in an effect process, is not limited to a symbol that can be replaced with any of all the symbols 180, such as the WILD symbol 181. For example, any symbol, e.g. “ORANGE”, may be the special symbol. In addition, “a special form” of display is not limited to the fixedly display. In the embodiment, as a result of the effect, the WILD symbol 181 is displayed, so that a winning probability is increased. However, a winning probability may be decreased. In addition, as a result of an effect process, a payout relating to a winning may be lowered. Furthermore, a special payout may not be performed.

It may be determined in advance when an effect process is started that a ball 41 is received in which receiver 42a to 42e. In this case, a movement of the ball 41 is controlled based on a result of the determination. Alternatively, it may be determined during an effect process that a ball 41 is received in which receiver 42a to 42e. To be more specific, a movement of the ball 41 may be randomly controlled and the ball 41 may be accidentally received in any one of the receivers 42a to 42e. In addition, in the embodiment, the main CPU waits until the ball 41 is received in any one of the receivers 42a to 42e, so that the ball 41 is without fail received in any one of the receivers 42a to 42e. However, the invention is not limited thereto. For example, it may be possible that the ball 41 is not received in any receiver 42a to 42e.

The bonus game is not limited to the above embodiment, as long as it is a game that is more advantageous to a player than a base game. Specifically, a game in which more game media can be obtained than in a base game, a game in which game media can be obtained in a higher probability than in a base game, a game in which consumption of the game media can be more suppressed than in a base game and the like may be adopted as a bonus game. For example, so-called a free game in which no game medium is consumed may be executed one or more times in a bonus game.

In the above embodiment, the symbols are displayed with the video reels in a base game and in a sub game executed in a bonus game. However, the invention is not limited. For example, mechanical reels may be used to display the symbols, or a combination of the mechanical reels and the video reels may be used to display the symbols. The vide reel may include a liquid crystal device, a CRT (cathode-ray tube) device, a plasma device and the like.

In a base game and in a sub game executed in a bonus game, the matrix of the symbols to be stopped after the scroll display is not limited to 5 colums/3 rows.

In the above embodiment, it is determined whether a winning is made, depending on a combination of the symbols stopped on the payline L, in a base game and in a sub game executed in a bonus game. However, the invention is not limited thereto. For example, when a certain symbol referred to as scattered symbol is displayed in the display after the scroll display, the payout may be made in accordance with the number of the scattered symbols displayed, irrespective of the payline L.

The invention may be implemented by software, as required.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A gaming machine that provides a first game and a second game different from the first game, the gaming machine comprising:
a first display that displays a plurality of areas in which symbols are displayed;
a second display that displays a plurality of receivers corresponding to the respective areas; and
a processor that operates:
to control the first display to variably display and then to stop the symbols in the first game;
to determine a winning of the first game in accordance with the stopped symbols;
to control the second display to display an image that a ball is received in any of the receivers, in the second game; and
to control the first display so that a symbol in an area corresponding to a receiver in which the ball is received is displayed in a special form, in the first game.

2. The gaming machine according to claim 1, wherein
the processor further operates
to change a payout number relating to a winning in accordance with the special form.

3. The gaming machine according to claim 1, wherein the
processor further operates
to control the first display so that a special symbol is fixedly displayed in an area corresponding to a receiver in which the ball is received, while the symbols are variably displayed and stopped in the first game, the special symbol being replaceable with any one of all the symbols.

4. The gaming machine according to claim 1, further comprising
a communicator that communicates with a host computer, the host computer managing a plurality of gaming machines including the gaming machine and dividing the gaming machines into groups which correspond to the receivers, respectively,
wherein the processor further operates:
to transmit a data item relating to the receiver in which the ball is received to the host computer via the communicator; and
to receive a payout data item about a special payout from the host computer via the communicator and to perform a special payout based on the payout data item, when the gaming machine belongs to a group corresponding to the receiver based on the data item relating to the receiver.

5. The gaming machine according to claim 1, wherein
the processor further operates:
to control the first display so that a special symbol is fixedly displayed in an area corresponding to a receiver in which the ball is received, while the symbols are variably displayed and stopped in the first game, the special symbol being replaceable with any one of all the symbols, and
to change a payout number relating to a winning in accordance with the special symbol fixedly displayed.

6. The gaming machine according to claim 1, further comprising
a communicator that communicates with a host computer, the host computer managing a plurality of gaming machines including the gaming machine and dividing the gaming machines into groups which correspond to the receivers, respectively,
wherein the processor further operates:
to change a payout number relating to a winning in accordance with the special form;
to transmit a data item relating to the receiver in which the ball is received to the host computer via the communicator; and
to receive a payout data item about a special payout from the host computer via the communicator and to perform a special payout based on the payout data item, when the gaming machine belongs to a group corresponding to the receiver based on the data item relating to the receiver.

7. The gaming machine according to claim 1, further comprising
a communicator that communicates with a host computer, the host computer managing a plurality of gaming machines including the gaming machine and dividing the gaming machines into groups which correspond to the receivers, respectively,
wherein the processor further operates:
to control the first display so that a special symbol is fixedly displayed in an area corresponding to a receiver in which the ball is received, while the symbols are variably displayed and stopped in the first game, the special symbol being replaceable with any one of all the symbols;
to transmit a data item relating to the receiver in which the ball is received to the host computer via the communicator; and
to receive a payout data item about a special payout from the host computer via the communicator and to perform a special payout based on the payout data item, when the gaming machine belongs to a group corresponding to the receiver based on the data item relating to the receiver.

8. The gaming machine according to claim 1, further comprising
a communicator that communicates with a host computer, the host computer managing a plurality of gaming machines including the gaming machine and dividing the gaming machines into groups which correspond to the receivers, respectively,
wherein the processor further operates:
to control the first display so that a special symbol is fixedly displayed in an area corresponding to a receiver in which the ball is received, while the symbols are variably displayed and stopped in the first game, the special symbol being replaceable with any one of all the symbols;
to change a payout number relating to a winning in accordance with the special symbol fixedly displayed;
to transmit a data item relating to the receiver in which the ball is received to the host computer via the communicator; and
to receive a payout data item about a special payout from the host computer via the communicator and to perform a special payout based on the payout data item, when the gaming machine belongs to a group corresponding to the receiver based on the data item relating to the receiver.

9. A control method of a gaming machine comprising the steps of:
controlling a first display to variably display and then to stop a plurality of symbols in a first game;
determining a winning of the first game in accordance with the symbols stopped in the first display;
controlling a second display to display an image that a ball is received in any of a plurality of receivers which correspond to the respective areas, in a second game different from the first game; and
controlling the first display so that a symbol in an area corresponding to a receiver in which the ball is received is displayed in a special form, in the first game.

10. The control method according to claim 9, further comprising the steps of
changing a payout number relating to a winning in accordance with the special form.

11. The control method according to claim 9, further comprising the steps of,
controlling the first display so that a special symbol is fixedly displayed in an area corresponding to a receiver in which the ball is received, while the symbols are variably displayed and stopped in the first game, the special symbol being replaceable with any one of all the symbols.

12. The control method according to claim 9, further comprising the steps of:
transmitting a data item relating to the receiver in which the ball is received to a host computer that manages a plurality of gaming machines including the gaming machine and divides them into groups which correspond to the receivers, respectively; and
receiving a payout data item about a special payout from the host computer and performing a special payout based on the payout data item, when the gaming machine belongs to a group corresponding to the receiver based on the data item relating to the receiver.

13. The control method according to claim 9, further comprising the steps of:
controlling the first display so that a special symbol is fixedly displayed in an area corresponding to a receiver in which the ball is received, while the symbols are variably displayed and stopped in the first game, the special symbol being replaceable with any one of all the symbols; and
changing a payout number relating to a winning in accordance with the special symbol fixedly displayed.

14. The control method according to claim 9 further of a gaming machine comprising the steps of:
changing a payout number relating to a winning in accordance with the special form;
transmitting a data item relating to the receiver in which the ball is received to a host computer that manages a plurality of gaming machines including the gaming machine and divides them into groups which correspond to the receivers, respectively; and
receiving a payout data item about a special payout from the host computer and performing a special payout based on the payout data item, when the gaming machine belongs to a group corresponding to the receiver based on the data item relating to the receiver.

15. The control method according to claim 9, further comprising the steps of:
controlling the first display so that a special symbol is fixedly displayed in an area corresponding to a receiver in which the ball is received, while the symbols are variably displayed and stopped in the first game, the special symbol being replaceable with any one of all the symbols;
transmitting a data item relating to the receiver in which the ball is received to a host computer that manages a plurality of gaming machines including the gaming machine and divides them into groups which correspond to the receivers, respectively; and
receiving a payout data item about a special payout from the host computer and performing a special payout based on the payout data item, when the gaming machine belongs to a group corresponding to the receiver based on the data item relating to the receiver.

16. The control method according to claim 9, further comprising the steps of:
controlling the first display so that a special symbol is fixedly displayed in an area corresponding to a receiver in which the ball is received, while the symbols are variably displayed and stopped in the first game, the special symbol being replaceable with any one of all the symbols;
changing a payout number relating to a winning in accordance with the special symbol fixedly displayed;
transmitting a data item relating to the receiver in which the ball is received to a host computer that manages a plurality of gaming machines including the gaming machine and divides them into groups which correspond to the receivers, respectively; and
receiving a payout data item about a special payout from the host computer and performing a special payout based on the payout data item, when the gaming machine belongs to a group corresponding to the receiver based on the data item relating to the receiver.
